(19) United States
(12) Patent Application Publication
(10) Pub. No.: US 2014/0014118 A1
(43) Pub. Date: Jan. 16, 2014

(54) Orthodotically Correcting and Grinding Protector Pacifier

(71) Applicant: Simona Cuevas, San Antonio, TX (US)

(72) Inventor: Simona Cuevas, San Antonio, TX (US)

(73) Assignee: Simona Cuevas, San Antonio, TX (US)

(21) Appl. No.: 13/546,698

(22) Filed: Jul. 11, 2012

(51) Int. Cl. A61C 5/14; A61J 17/00

(52) U.S. Cl. 128/861

(57) ABSTRACT

This occlusal grinding protective device and orthodontic aligner is intended for intraoral use in children ages 1 to 6 years old, who exhibit symptoms of teeth grinding and in those who exhibit teeth changes due to prolonged tongue thrusting, thumb sucking, and deformation due to prolonged pacifier use. The appliance separates the upper teeth from the lower teeth and keeps the user from further destruction of their teeth due to grinding. It has facial guide planes attached to the grinding plate. These so called lip bumpers will maintain teeth and jaws in ideal occlusal relationship. In children who suffer from misalignment (teeth or skeletal) and are grinding, the lip bumpers will serve to orthodontically guide the teeth into ideal class I occlusions, whereby still protecting teeth from damage due to grinding. Its suggested wear time is at night during sleep.

### BACKGROUND OF THE INVENTION

This invention pertains to the field of dentistry. It fills a void in the professional and home care sector for teeth grinding and teeth misalignment in children ranging in ages 1 to 6. Professional dental studies have shown that more than 80% of toddlers grind their teeth starting when the first deciduous teeth erupt. This has a debilitating impact on the affected children's dentition, and is a habit that can continue throughout life, with severe consequences. No device exists presently on the market that helps children protect their dentition from this harmful habit. Additionally, many children suffer from teeth misalignment genetically or self-induced due to tongue thrusting, thumb sucking or prolonged pacifier use. No universal treatment appliances exist to date that address these issues either, for home use at such an early age. Although bruxism (grinding) is an established harmful habit that has been researched in depth and for which many adult appliances exist, the habit can begin as the early as the eruption of the first teeth. The appliances currently available only address this issue in the adult dentition. If treated at the earliest stages of formation, this debilitating habit and its side effects could be prevented and maybe eradicated. This appliance specifically addresses this problem. Additionally, this device also addresses the teeth and jaw misalignment in young children that, today, are only being treated in professional dental offices with lengthy, uncomfortable and costly customized treatment modalities. This appliance begins to treat, if not completely correct, these issues effectively in an easy, non-invasive, non-painful way at minimal cost, at home.

### REFERENCES

1. Dao T T, Lavigne G j. Oral splints: The crutches for temporomandibular disorders and bruxism? Crit Rev Oral Biol Med 1998;9:345-361

2. de Leeuw R (ed). Americal Academy of Orofacial Pain Guidelines for Assessment, Diagnosis, and Management, ed 4. Chicago: Quintessence, 2008.

3. The Cochrane Collaboration. The Cochrane Policy manual, Issue 3, 2009. The Cochrane website. www.cochrane.org/admin/manual.htm. Accessed 30 Apr. 2010.

4. Moher D, Cook D J, Eastwood S, Olkin I, Rennie D, Stroup D F Improving the quality of reports of meta-analyses of randomized controlled trials: The QUOROM statement. Quality of reporting of meta-analyses. Lancet 1999;354:1896-1900.

5. Friction J N, Nixdorf D R, Schiffman E L, Ouyang W, Velly A M, Look J O. Critical appraisal of methods used in randomized controlled trials of treaments for temporomandibular disorders. J Orofac Pain 2010;24:139-151.

6. Methods for Systematic Reviews. The Oxford Centre for Evidence-based Medicine website. http://www.cebm.net. Accessed 30 Apr. 2010.

7. Egger M, Jüni P, Bartlett C, Holestein F, Sterne J. How important are comprehensive literature searches and the assessment of trial quality in systematic reviews? Empirical study. Health Technol Assess 2003;7:1-76.

8. The International Headache Classification (ICHD-2), ed 2. The International Headache Society website. http://ihs-classification.org/en/. Accessed 30 Apr. 2010.

9. Dworkin R H, Turk D C, Farrar J T, et at. Core outcome measures for chronic pain clinical trials: IMMPACT recommendations. Pain 2005;113:9-19.

10. Al-Hasson H K, Ismail A I Jr, Ash M M. Concerns of patients seeking treatment for TMJ dysfunction. J Prosthet Dent 1986;56:217-221.

11. Higgins J P, Green S. Assessment of study quality. In: Cochrane Handbook for Systematic Reviews of Interventions 4.2.5, 2005. UCSF Global Health Sciences website. http://globalhealthsciences.ucsf.edu/PPHG/. Accessed 30 Apr. 2010.

12. Forssell H, Kalso E. Application of principles of evidence-based medicine to occlusal treatment of temporomandibular disorders: Are these lessons to be learned? J Orofac Pain 2004:9-22.

13. Ioannidis J E, Evans S J, Gotzsche P C, et al. Better reporting of harms in randomized trials: An extension of the CONSORT statement. Ann Intern Med 2004;141:781-788.

14. Kalso E, Edwards J, McQuay H J , Moore R A. Five easy pieces of evidence-based mediine. Eur J Pin 2001;5:227-230.

15. Chatellier G, Zapletal E, Lemaitre D, Menard J, Degoulet P. The number needed to trate: A clinically useful nomo-gram in its proper context. BMJ 1996;312:426-429.

16. Kleinbaum D G, Kupper L L, Morgenstern H. Epidemiological Research: Prinicples and Quantitative Methods. New York: Van Nostrand Reinhold, 1982.

17. Chinn S A simple method for converting odds ratio to effect size for use in meta-analysis. Stat Med 2000;19:3127-3131.

18. Rubinoff M S, Gross A. McCall W D Jr. Conventional and non-occluding splint therapy compared for patients with myofascial pain dysfunction syndrome. Gen Dent 1987;35:502-506.

19. Dao T T, Lavigne G J, Charbonneau A, Feine J S, Lund J P. The efficacy of oral splints in the treatment of myofascial pain of the jaw muscles: A controlled clinical trial. Pain 1994;56:85-94.

20. Ekberg E C, Sabet M E, Petersson A, Niler M. Occlusal appliance therapy in a short-term perspective in patients with temporomandibular disorders correlated to condyle position. Int J Prosthodont 1998;11:263-268.

21. Ekberg E C, Vallon D, Niler M. Occlusal appliance therapy in patients with temporomandibular disorders. A double-blind controlled study in a short-term perspective. Acta Odontol Scand 1998;56:122-128.

22. Ekberg E, Niler M. The influence of stabilization appliance therapy and other factors on the treatment outcome in patients with temporomandibular disorders of arthrogeneous origin. Swed Dent J 1999;23:39-47.

23. Raphael K G, Marbach J J. Widespread pain and the effectiveness of oral splints in myofascial face pain. J Am Dent Assoc 2001;132:305-316.

24. Ekberg E, Vallon D, Niler M. The efficacy of appliance therapy in patients with temporomandibular disorders of mainly myogenous origin. A randomized, controlled, short-term trail. J Orofac Pain 2003;17:133-139.

25. Wassell R W, Adams N, Kelly P J. Treatment of temporomandibular disorders by stabilizing splints in general dental practice: results after initial treatment. Br Dent J 2004;197:35-41.

26. Conti P C, dos Santos C N, Kogawa E M, de Castro Ferreira Conti A C, de Araujo Cdos R. The treatment of painful temporomandibular joint clicking with oral splints: A randomized clinical trial. J Am Dent Assoc 2006;137:1108-1114.

27. Johansson A, Wenneberg B, Wagersten C, Haraldson T. Acupuncture in treatment of facial muscular pain. Acta Odontol Scand 1991;49:153-158.

28. List T, Helkimo M, Andersson S, Carlsson G E. Acupuncture and occlusal splint therapy in the treatment of craniomandibular disorders. Part I. A comparative study. Swed Dent J 1992;16:125-141.

29. List T, Helkimo M, Karlsson R. Pressure pain thresholds in patients with craniomandibular disorders before and after treatment with acupuncture and occlusal splint therapy: A controlled clinical study. J Orofac Pain 1993;7:275-282.

30. Lundh H, Westesson P L, Eriksson L, Brooks S L. Temporomandibular joint disk displacement without reduction. Treatment with flat occlusal splint versus no treatment. Oral Surg Oral Med Oral Pathol 1992;73:655-658.

31. Lundh H, Westesson P L, Jisander S, Eriksson L. Disk-repositioning onlays in the treatment of temporomandibular joint disk displacement: Comparison with a flat occlusal splint and with no treatment. Oral Surg Oral Med Oral Pathol 1988;66:155-162.

32. Dahlström L, Carlsson G E, Carlsson S G. Comparison of effects of electromyographic biofeedback and occlusal splint therapy on mandibular dysfunction. Scand J Dent Res 1982;90:151-156.

33. Okeson J P. The effects of hard and soft occlusal splints on nocturnal bruxism. J Am Dent Assoc 1987;1114:788-791.

34. Dalström L, Carlsson S G. Treatment of mandibular dysfunction: The clinical usefulness of biofeedback in relation to splint therapy. J Oral Rehabil 1984;11:277-284.

35. Crockett D J, Foreman M E, Alden L, Blasberg B. A comparison of treatment modes in the management of myofascial pain dysfunction syndrome. Biofeedback Self Regul 1986;11:279-291.

36. Turk D C, Rudy T E, Kubinski J A, Zaki H S, Greco C M. Dysfunctional patients with temporomandibular disorders: Evaluating the efficacy of a tailored treatment protocol. J Consult Clin Psychol 1996;64:139-146.

37. Wahlund K, List T, Larss 203-211.

38. Manns A, Miralles R, Santander H, Valdivia J. Influence of the vertical dimension in the treatment of myofascial pain-dysfunction syndrome. J Prosthet Dent 1983;50:700-709.

39. Carlson C R, Bertrand P M, Ehrlich A D, Maxwell A W, Burton R G. Physical self-regulation training for the management of temporomandibular disorders. J Orofac Pain 2001;15:47-55.

40. Truelove E, Huggins K, Mancl L, Dowrkin S. The efficacy of traditional, low-cost and nonsplint therapies for temporomandibular disorder: A randomized controlled trail. J Am Dent Assoc 2006;137:1099-1107.

41. Schokker R P, Hansson T L, Ansink B J. The result of treatment of the masticatory system of chronic headache patients. J Craniomandib Disord 1990;4:126-130.

42. De Tommaso M, Shevel E, Libro G, et al. Effects of amitriptyline and intra-oral device appliance on clinical and laser-evoked potentials features in chronic tension type headache. Neurol Sci 2005;26(suppl 2):5152-5154.

43. Wenneberg B, Nystrom T, Carlsson G E. Occlusal equilibration and other stomatognathic treatment in patients with mandibular dysfunction and headache. J Prosthet Dent 1988;59:478-483.

44. Davies S J, Gray R J. The pattern of splint usage in the management of two common temporomandibular disorders. Part O: The anterior repositioning splint in the treatment of disc displacement with reduction. Br Dent J 1997;183:199-203.

45. Davies S J, Gray R G. The pattern of splint usage in the management of two common temporomandibular disroders. Part II: The stabilization splint in the treatment of pain dysfunction syndrome. Br Dent J 1997;183:247-251.

46. Dahlström L, Haraldson T. Bit plates and stabilization splints in mandibular dysfunction. A clinical and electromyographic comparison. Acta Odontol Scand 1985;43:109-114.

47. Gray R J, Davies S J, Guayle A A, Wastell D G. A comparison of two splints in the treatment of TMJ pain dysfunction syndrome. Can occlusal analysis be used to predict success of splint therapy? Br Dent J 1991;170:55-58.

48. Anderson G C, Schulte J K, Goodkind R J. Comparative study of two treatment methods for internal derangement of the temporomandibular joint. J Prosthet Dent 1985;53:392-397.

49. Wright E, Anderson G, Schulte J. A randomized clinical trial of intra-oral soft splints and palliative treatment for masticatory muscle pain. J Oroac Pain 1995;9:192-199.

50. Elsharkawy T M, Ali N M. Evaluation of acupuncture and occlusal splint therapy in the treatment of temporomandibular joint disorders. Egypt Dent J 1995;41:1227-1232.

51. Carmeli E, Sheklow S L, Bloomenfeld I. Comparative study of repositioning splint therapy and passive manual range of motion techniques for anterior displaced temporomandibular discs with unstable excursive reduction. Physiotherapy 2001;87:26-36.

52. Shankland W E II. Migraine and tension-type headache reduction through pericranial muscular suppression: A preliminary report. Cranio 2001;19:269-278.

53. Magnusson T, Adiels A M, Nilsson H L, Helkimo M. Treatment effect on signs and symptoms of temporomandibular disorders: Comparison between stabilization splint and a new type of splint (NTI). A pilot study. Swed Dent J 2004;28:11-20.

54. Jokstad A, Mo A, Krogstad N S. Clinical comparison between two different splint designs for temporomandibular disorder therapy. Acta Odontol Scand 2005;63:218-226.

55. Dworkin SF, LeResche L. Research diagnostic criteria for temporomandibular disorders: Review, criteria, examinations and specifications, critique [review]. J Craniomandib Disorder 1992;6:301-355.

56. Turk D C, Dworkin R H, Allen R R, et al. Core outcome domains for chronic pain clinical trials: IMMPACT recommendations. Pain 2003;106:337-345.

57. Dworkin R H, Turk D C, Farrar J T, et al. Core outcome measures for chronic pain clinical trials: IMMPACT recommendations. Pain 2005;113:9-19.

58. Forssell H, Kalso E, Koskela P, Vehmanen R, Puukka P, Alanen P. Occlusal treatments in temporomandibular disorders: A qualitative systematic review of randomized controlled trails. Pain 1999;83:549-560.

59. Kreiner M, Betancor E, Clark G T. Occlusal stabilization appliances. Evidence of their efficacy. J Am Dent Assoc 2001;132:770-777.

60. Türp J K, Komine F, Hugger A. Efficacy of stabilization splints for the treatment of patients with masticatory muscle pain: A qualitative systematic review. Clin Oral Invest 2004;8:179-195.

61. Al-Ani Z, Gray R H, Davies S J, Sloan P, Glenny A M. Stabilization splint therapy for the treatment of temporomandibular myofascial pain: A systematic review. J Dent Educ 2005;69:1242-1250.

62. Ernst E, White A R. Acupuncture as a treatment for temporomandibular joint dysfunction: A systematic review of randomized trails. Arch Otolaryngol Head Neck Surg 1999;125:269-272.

63. Cridler A B, Glaros A G. A meta-analysis of EMG biofeedback treatment of temporomandibular disorders. J Orofac Pain 1999;13:29-37.

64. List T, Helkimo M, Acupuncture and occlusal splint therapy in the treatment of craniomandibular disorders. II. A 1-year follow-up study. Acta Odontol Scand 1992;50:375-385.

65. Raustia A M, Pohjola R T, Virtanen K K. Acupuncture compared with stomatognathic treatment for TMJ dysfunction. Part I: A randomized study. J Prosthet Dent 1985;54:581-585.

66. Turk D C, Said H S, Rudy T E. Effects of intra-oral appliance and biofeedback/stress management alone and in combination in treating pain and depression in patients with temporomandibular disorders. J Prosthet Dent 1993;70:185-164.

67. Linde C, Isacsson G, Jonsson B G. Outcome of 6-week treatment with transcutaneous electric nerve stimulation compared with splint on symptomatic temporomandibular joint disc displacement without reduction. Acta Odontol Scand 1995;53:92-98.

68. Magnusson T, Syren M. Therapeutic jaw exercises and interocclusal appliance therapy. A comparison between two common treatments of temporomandibular disorders. Swed Dent J 1999;23:27-37.

69. Alvarez-Arenal A, Junquera L M, Fernandez J P, Gonzalez I, Olay S. Effects of occlusal splint and transcutaneous electric nerve stimulation on the signs and symptoms of temporomandibular disorders in patients with bruxism. J Oral Rehabil 2002;29:858-863.

70. Manns A, Miralles R, Cumsille F. Influence of vertical dimension on masseter muscle electromyographic activity in patients with mandibular dysfunction. J Prosthet Dent 1985;53:243-247.

71. Fayed M M, El-Mangoury N H, El-Bokle D N, Belal A I. Occlusal splint therapy and magnetic resonance imaging. World J Orthod 2004;5:133-140.

72. Schmitter M, Zahran M, Duc M J, Henschel V, Rammelsberg P. Conservative therapy in patients with anterior disc displacement without reduction using 2 common splints: A randomized clinical trial. J Oral Maxillofac Surg 2005;63:1295-1303.

73. Stiesch-Sholz M, Kempert J, Wolter S, Tschernitschek H, Rossbach A. Comparative prospective study on splint therapy of anterior disc displacement without reduction. J Oral Rehabil 2005;32:474-479.

### BRIEF SUMMARY OF THE INVENTION

This grinding protector and orthodontic aligner is an active orthotic appliance that is recommended for children who grind their teeth, have misaligned teeth or both. It can be used in children starting when first deciduous teeth erupt all the way to children in the mixed dentition stage. This appliance incorporates a non-rigid bite plane which comfortably fits toddlers from 1 to 6 years old. It has facial bumpers approximately 30 mm long, one for the maxillary and one for the mandibular arch (lingually offset by 3 mm) These bumpers are connected to the grinding plate constructed from a reinforced non-malleable plastic with rounded corners. These guiding teeth bumpers are confined to the anterior region only as to not interfere with the horizontal teeth and jaw growth. This appliance, due to the fact that it is connected to an external pacifier head, cannot be swallowed. It disoccludes both arches not permitting any tooth contact. It does not impede any natural growth patterns of the children's teeth and jaw (dental or skeletal).

### BRIEF DESCRIPTION OF DRAWINGS

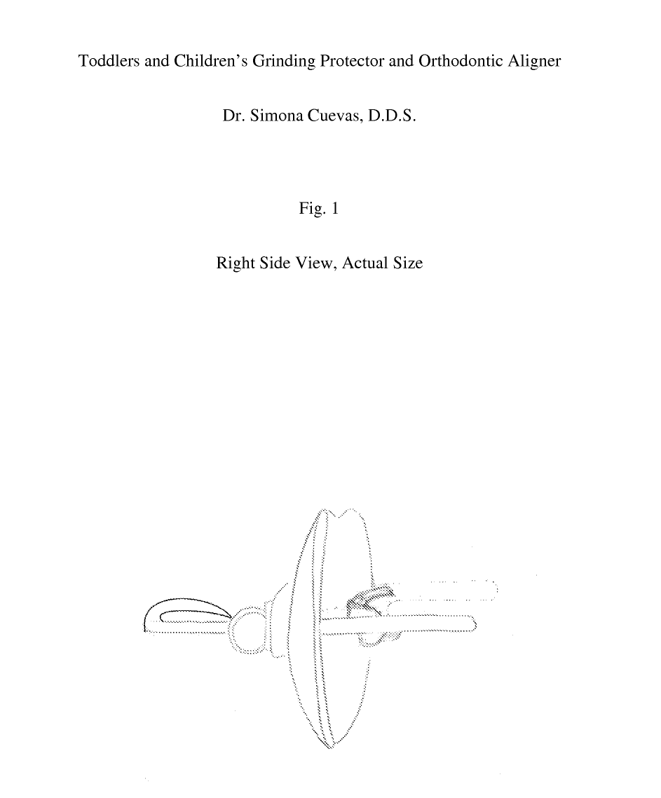

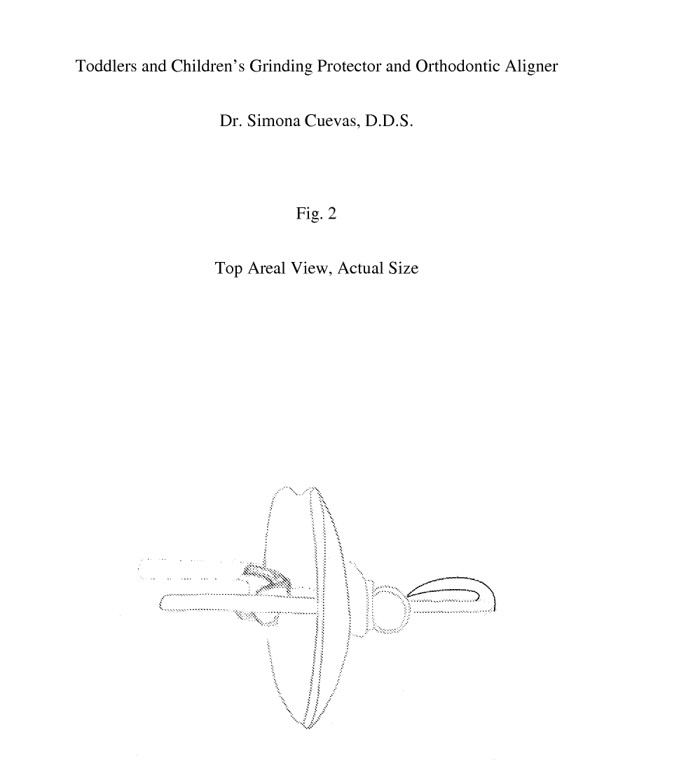

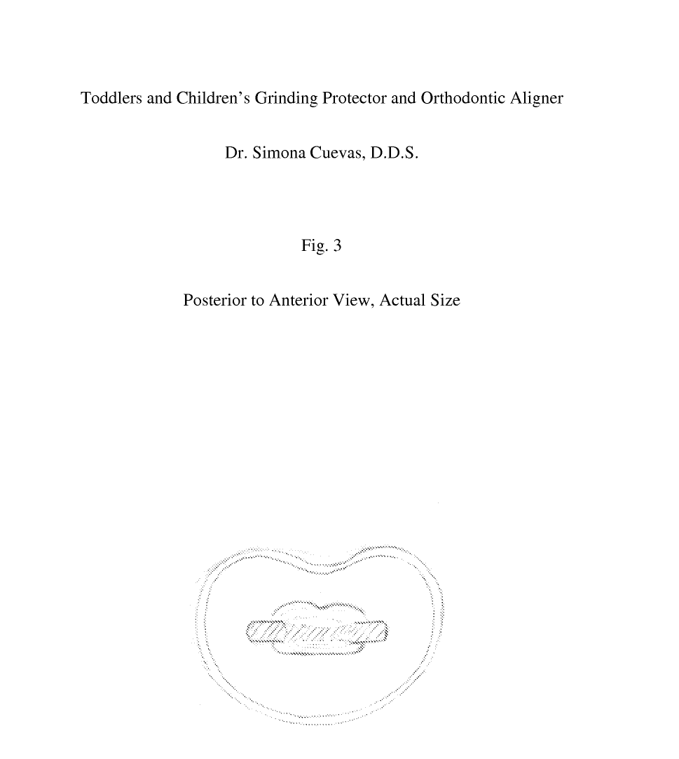

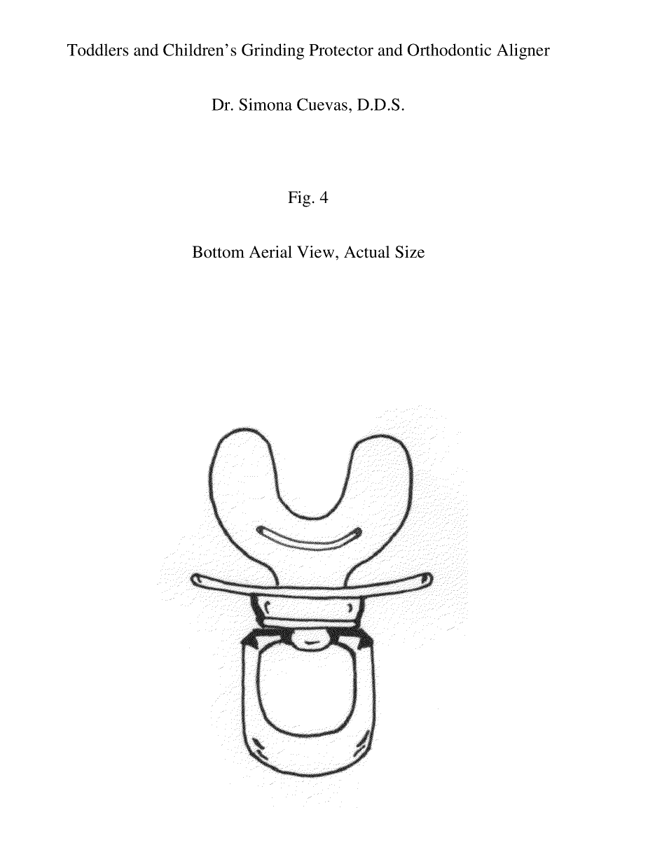

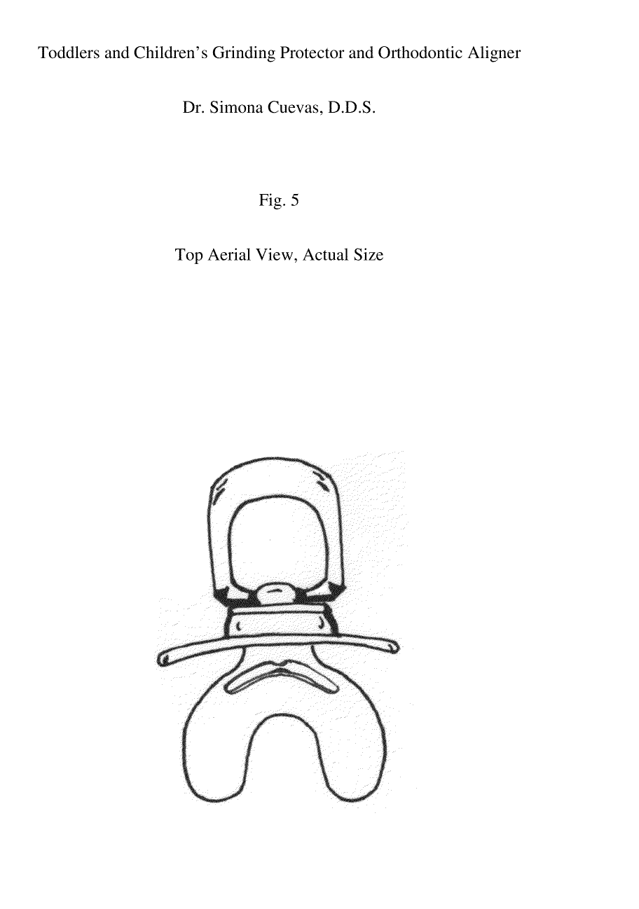

There are five pages (PDF files) of drawings, each only showing one figure per page. Each page is listed with the title, figure number, view, and page number. FIGS. 1 and 2 refer to the right (FIG. 1) and left (FIG. 2) side view of the Toddlers & Children's Grinding Protector and Orthodontic Aligner. FIG. 3 is a posterior to anterior view of the device. FIG. 4 is a bottom aerial view of the appliance, and FIG. 5 is a top aerial view.

This device is intended for intra-oral use by children ranging from 1 to 6 years of age. It is to be constructed from professional dental grade mouth guard material 0.0160″ in thickness, in a universal size only. The maxillary and mandibular guide planes (lip bumpers) respectively, are attached to this arch shaped grinding plane. They are made from a non-pliable reinforced resin. A generic pacifier head attaches to the grinding plate for proper positioning and retention in the mouth (depicted in all five figures).

### DETAILED DESCRIPTION OF INVENTION

This active intra-oral appliance serves as a grinding protector and teeth/jaw orthodontic aligner. This device protects the growing dentition from unnecessary wear and destruction caused by the harmful grinding habits. It also works to orthodontically realign the teeth into proper class I occlusion. Its intended users are children starting at ages one to approximately age six, keeping in mind that the device easily accommodates the growing jaw size at each age making it a universal fit. It is an extremely comfortable and easy to use appliance allowing free, non-constricting jaw movement, and continuous uninhibited teeth and jaw growth on all planes. In order to keep this device safe for children, it is attached to an external pacifier head which prevents swallowing of the device. In cases where the only pathology present is grinding, the teeth guide planes (lip bumpers) will not affect the present ideal occlusion in any way. In cases where dental or skeletal pathology has already occurred and the child has self-induced misalignment due to different habits, this appliance will help in guiding the existing hard tissue into proper alignment and prevent additional misalignment from occurring. This appliance will intervene at a developmental stage where professional orthodontic treatment cannot be started yet. It will at minimum keep additional damage from happening until orthodontic intervention can occur and at best fix minor problems and preclude necessity for future orthodontic and/or TMJ therapy. All while protecting the erupted teeth from grinding damage.

This device is constructed from a horseshoe shaped chew resistant, yet comfortable for biting forces, plastic occlusal plane (made from professional grade 0.0160 inch dental mouth-guard material) with hard resin reinforced facial lip bumpers—teeth guide planes—on the superior and inferior aspects respectively. The bite plane serves as an arch separator and biting plane whereby the lip/teeth bumpers serve as orthodontic correcting aligners. The lip bumpers are positioned in ideal class I occlusion with ideal over-jet. The guide plane for the mandibular teeth is positioned lingually to the maxillary one, by approximately 3 mm (to mimic ideal inter-occlusal relationship). The maxillary teeth guide plane has a notch in the middle of its facial aspect which allows for the maxillary frenum to be undisturbed, regardless of size. Their facial curvature is molded with ideal arch contour. The guide planes are only 30 mm long (the average distance from canine to canine in a small child). The maxillary lip bumper is at its highest point 8 mm tall (the average length of a deciduous maxillary central incisor), and the mandibular lip bumper is 5 mm at its highest point (the average length of mandibular incisor). Both guide planes are rounded at their respective distal corners (at the approximate level of the canine where the natural jaw shape curves and posterior teeth begin) and slope down and disappear into the grinding plate. The reason for this is so it won't affect the lateral growth pattern of the jaw and also to not interfere with free lip movement and development. This active orthotic device is attached to an extra-oral pacifier head, which is meant to help the child keep the appliance in proper position, from freely moving intra-orally or swallowing it. There is a 6 mm neck/attachment between the facial aspect of the lip bumper to the external pacifier head. This neck allows unimpeded room for lip placement.

Due to the integration of scientifically recorded average measurements of children's teeth and jaw sizes ages 1-6 and the careful construction of this appliance, it is a universal fit for children in this age range.

1. The claim for the “Toddlers and Children's Grinding Protector and Orthodontic Aligner” is that this intraoral appliance, will work as a universal fit, active orthotic device in children ages 1 to 6 by:
1. preventing teeth damage from grinding in the deciduous and mixed dentition.
2. guiding misaligned teeth and jaws into an ideal class I growth pattern and precluding costly future extensive orthodontic, restorative and TMJ treatments.
This device is intended to be an active orthotic device, which does not exhibit any negative side effects to the user. It intervenes in the developmental growth stage in children, where the need is substantial and no professional or over the counter appliance exists (of any type) to address this need to date.
This device satisfies the professional demand for an appliance that will allow the user to prevent serious debilitating damage by:
1. preventing continuous damage to teeth and jaws (as a grinding protector).
2. realigning distorted dentition or jaws (as an orthodontic aligner).
Without the availability of this “Toddlers and Children's Grinding Protector and Orthodontic Aligner” on the market, children will continue to damage their teeth from grinding. In cases where they have already misaligned their teeth and distorted their jaw shape (from thumb sucking, prolonged pacifier use, or tongue thrusting), the only treatment modality now, if even still possible, is a surgery or complicated orthodontic treatment fix, years later when growth has stopped.
The pain and years of debilitating, esthetic and functional problems that now constantly arise from these harmful habits in children, could be easily prevented with this practical and affordable appliance.
This appliance will prevent or minimize the necessity for future costly orthodontic or surgical interventions.
